(19) United States
(12) Patent Application Publication
(10) Pub. No.: US 2013/0243236 A1
(43) Pub. Date: Sep. 19, 2013

(54) WIRELESS HEADPHONE JEWELRY

(71) Applicant: GO-DEF, INC., Ravenna, OH (US)

(72) Inventors: Rich Chamness, Ravenna, OH (US); Randi Labrier, Ravenna, OH (US)

(73) Assignee: Go-Def, Inc., Ravenna, OH (US)

(21) Appl. No.: 13/778,837

(22) Filed: Feb. 27, 2013

Related U.S. Application Data
(60) Provisional application No. 61/603,672, filed on Feb. 27, 2012.

(51) Int. Cl. H04R 1/10

(52) U.S. Cl. CPC H04R 1/10
USPC 381/378

(57) ABSTRACT

The present invention is directed to wireless headphone devices adapted to be worn as jewelry when in a storage position.

### CROSS-REFERENCE TO RELATED APPLICATIONS

This utility patent application claims priority to provisional patent application No. 61/603,672, entitled “Wireless Headphone Jewelry,” filed Feb. 27, 2012, the contents of which are hereby incorporated by reference herein.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable:

### BACKGROUND OF THE INVENTION

1. Field of the Invention

This invention relates generally to wireless headphone technologies and other audio speaker and microphone devices that are conveniently available to users by virtue of their configuration and use as wearable jewelry.

2. Description of Related Art

It is well known in the art to utilize headphones to listen to music being played by a personal audio electronics device 1 such as a radio, tape player, compact disc player, portable digital media player, smartphone or other electronic audio storage and playback device. Additionally, in recent years hands-free headset devices, not shown, have become an increasingly popular way for users to engage in phone conversations without holding the phone 1 to the user's ear. Unfortunately, known headphone and hands-free headset device designs are plagued with a variety of problems that impede convenient use and storage.

For example, as generally illustrated in FIG. 1, traditional headphones 2 consisted of a hoop band 4 with two ends 6 that are operatively connected to speakers (acoustic transducers 8); the acoustic transducers 8 are, in turn, connected to the personal audio electronics device 1 by wires 10; said wires 10 communicating audio sounds 100 generated by the personal audio electronics device 1 to users whose ears are situated in close proximity to the acoustic transducers 8. FIG. 1 also generally shows an illustrative hands-free headset apparatus 2a having a microphone 14 that permits a phone user to speak in a responsive manner to phone audio signals received through the acoustic transducers 8. Users of traditional headphones 2, and/or hands-free headsets 2a, quickly discovered that the wires 10 become tangled when the headphones 2 are not in use; that storage and transport of the bulky and irregularly shaped headphones 2 is difficult; and that headphone materials are fragile and easily broken, and heavy and uncomfortable when in use.

In subsequent versions of headphones, designers have attempted to overcome the aforementioned problems in various ways. Headphone hoop bands 4, as illustrated in FIGS. 1 and 2, have incorporated hinges 12, and other such components, that permit the headphones 1 to be folded into a more compact form when not in use. In some versions, not shown, the acoustic transducers 8 are sufficiently small that they may be partially inserted into the listener's ears; in these forms, the hoop band 4 is removed altogether, in a type known as “in ear” or “ear bud” headphones. In still other versions, not shown, wireless communications protocols, such as Bluetooth®, exchange/communicate data containing audio sounds 100 between a personal audio electronics device 1 and wireless headphones (of either the hoop band or in ear variety), thereby removing the wires 10 from the headphone assembly.

None of these modifications, however, have sufficiently resolved the problems of the prior art: headphones modified to be folded are still clunky and prone to breakage; in ear headphones still contain wires that get tangled; and wireless Bluetooth® headphones and headsets are small enough that they are easily lost (or require a separate case for storage purposes). What is needed, therefore, is a headphone assembly that is wireless, easily and compactly converted into a storage position, and capable of being fashionably worn by the user when in the storage position.

Bi-stable springs have two equilibrium positions, and are generally exemplified by the widely recognized “slap bracelet” device. The slap bracelet consists of layered flexible steel bands sealed within a fabric or plastic cover. In a first equilibrium position, the slap bracelet is flat or planar. In a second equilibrium position, the device is transformed from the flat position into a substantially secure semi-circular or curled position when slapped against a user's wrist. To date, slap bracelets have been utilized solely in association with decorative bracelets, and not for the purpose of securely and compactly permitting electronics devices to be worn on the user when not in use.

### BRIEF SUMMARY OF THE INVENTION

According to one embodiment of the invention, an inventive headphone apparatus designed to be worn as jewelry when in a storage position comprises a flexible substrate having two ends; and one or more acoustic transducers operatively attached to the end(s) of said flexible substrate; wherein the flexible substrate is: a) biased to curl into a semi-circular storage position substantially conforming and wrapping around a user's wrist when in a storage position, and b) adapted to releasably situate the headphones over a user's ears in a substantially U-shaped configuration when in a use position.

According to another embodiment of the invention, an inventive headphones apparatus designed to be worn as jewelry when in a storage position comprises a flexible substrate comprising a pair of electrically conductive metal spring bands having two ends and a parallel arrangement; an outer layer that substantially encases the flexible substrate; and one or more acoustic transducers, operatively attached to the end(s) of said flexible substrate; wherein the flexible substrate is: a) biased to curl into a semi-circular helical storage position substantially conforming and wrapping around a user's wrist when in a storage position, and b) adapted to releasably situate the headphones over a user's ears in a substantially U-shaped configuration when in a use position; and wherein connection between the acoustic transducers and spring bands establishes an electrical connection.

In one embodiment of the present invention, the headphone apparatus is a bi-stable structure.

In other embodiments of the present invention, the inventive headphone apparatus also includes a microphone permitting operation of the device as a hands-free phone headset.

One advantage of the present invention is that headphones can conveniently and fashionably be worn and transported as jewelry when in a storage position.

Another advantage of the present invention is that the headphones do not have connection wires that can get tangled when not in use, and do not need a case for transport when in a storage position.

Still other benefits and advantages of the invention will become apparent to those skilled in the art to which it pertains upon a reading and understanding of the following detailed specification.

### BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is set of traditional headphones from the prior art.

FIG. 2 is a set of prior art headphones shown in a storage position.

FIGS. 3 and 3a are perspective views of the jewelry headphones of the present invention, shown in the use position.

FIG. 4 is a perspective view of the jewelry headphones of the present invention, shown in a planar first storage position.

FIG. 5 is a perspective view of the jewelry headphones of the present invention, shown in a transition stage between a planar first storage position and a semi-circular second storage position (transition state).

FIGS. 6 and 6a are perspective views of the jewelry headphones of the present invention, shown in a semi-circular curled second storage position.

FIG. 7 is a view of one embodiment of the present invention.

FIGS. 8 and 8a are perspective views of the jewelry headphones of the present invention in a use position, without the outer layer assembled in order to better illustrate the arrangement of spring bands.

FIGS. 9 and 9a are perspective views of the jewelry headphones of the present invention, according to one embodiment, and shown in a use position on the user's head and in a semi-circular storage position around the user's wrist.

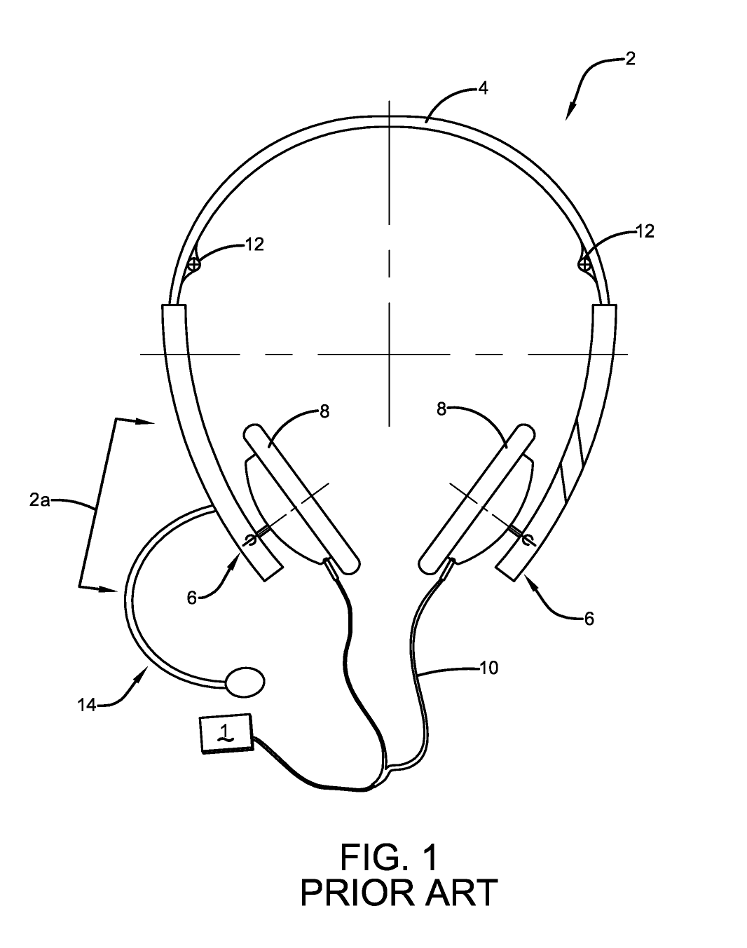

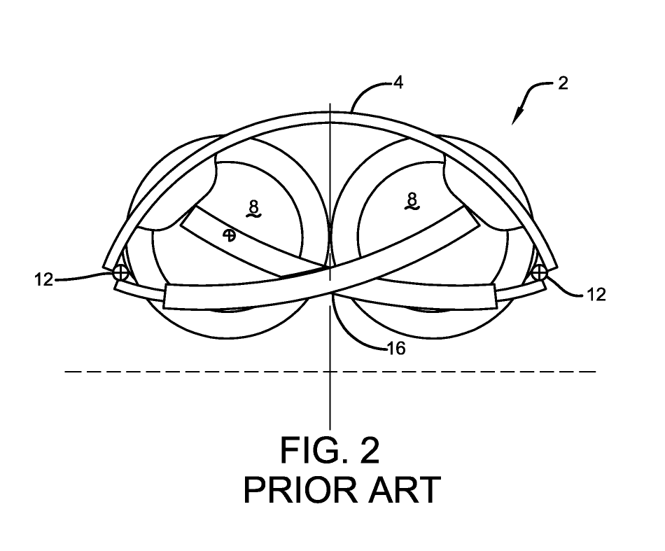

### DETAILED DESCRIPTION OF THE INVENTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting. In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

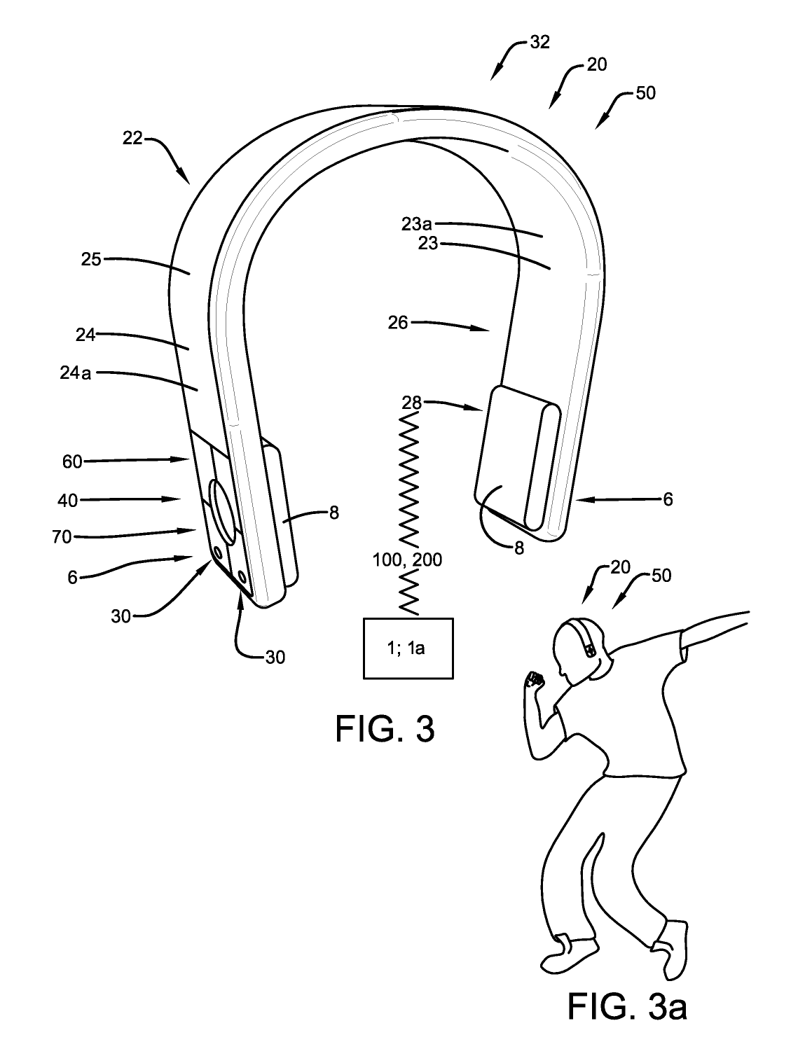

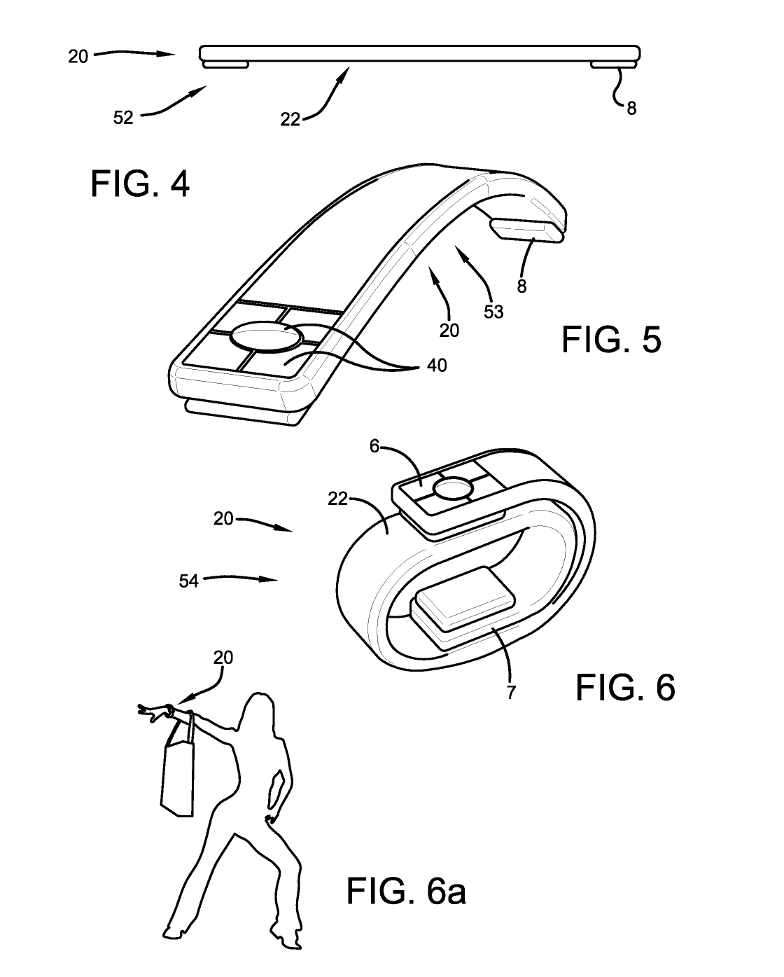

According to one embodiment, the jewelry headphone 20 of the present invention is shown in FIGS. 3-6. According to this embodiment, the jewelry headphone 20 is a bi-stable structure: one that has at least two stable mechanical shapes (equilibrium states). According to this embodiment, the jewelry headphones 20 are capable of taking on three different fixed states—a use position 50, a planar first storage position 52, and a semi-circular or rounded second storage position 54—and various transitional states 53 in between. FIGS. 3 and 3a show the jewelry headphones 20 in a substantially U-shaped use position 50, designed to sit atop a user's head in a semi-circular shape so that the acoustic transducers 8 can be situated in close proximity to the user's ears. FIG. 4 shows the jewelry headphones in a planar first storage position 52. FIG. 5 shows the jewelry headphones 20 in a transitional state 53 where the headphones are being converted from a first storage position 52 into a second storage position 54. FIG. 6 shows the jewelry headphones 20 in a second storage position 54, where the headphones are being worn by the user as jewelry; in this second storage position 54 the jewelry headphones 20 are easily and conveniently wrapped around the user's wrist or arm and transported with the user until their use/operation is desired.

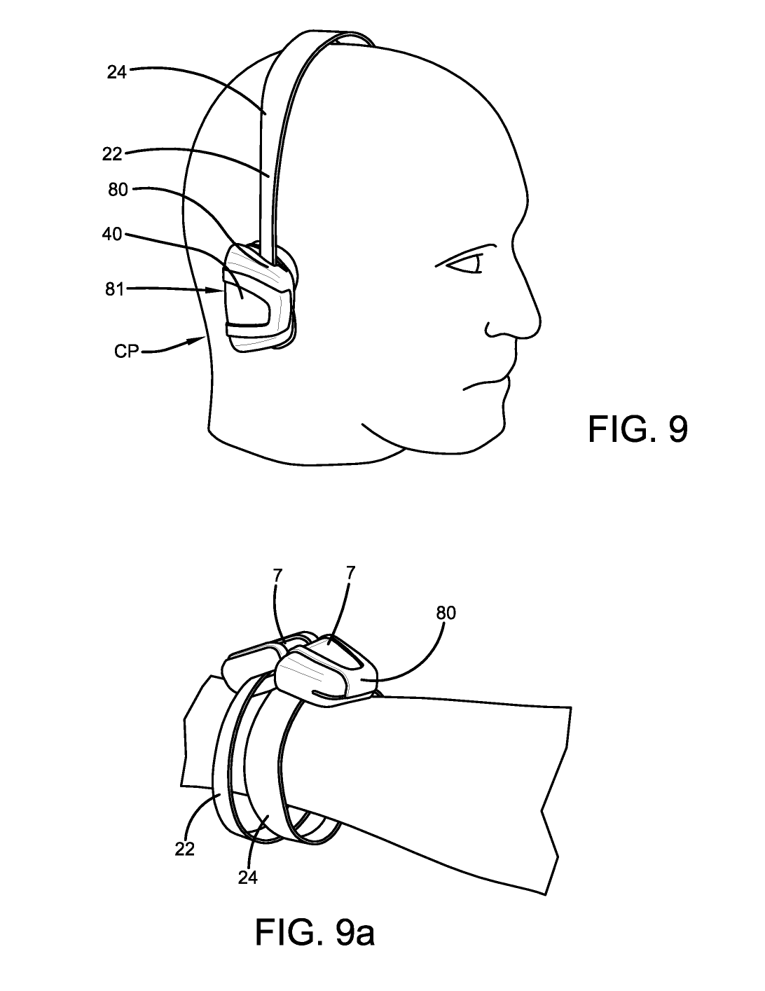

As shown in FIGS. 3-6, the jewelry headphones 20 are capable of being moved into various positions depending on whether the owner is using them to listen to or send audio signals to a personal audio electronics device 1(1a) (“use position” 50), or when the owner needs to convert them into a convenient storage position (a first storage position 52, where the jewelry headphones 20 are in a substantially planar position) (or a second storage position 54, where the jewelry headphones are wrapped in a semi-circular curled shape that substantially conforms to the user's wrist or arm, or other user appendage, and worn and transported with the owner as “jewelry”). A critical aspect of the second storage position 54 is that the spring band conforms to the user's wrist in a wrap manner that is close enough to the user's skin—as with wearing a watch that it prevents the headphones 20 from easily slipping over the user's hand. In some embodiments, the jewelry headphone 20 ends 6 may partially or substantially overlap other portions of the spring band, as is shown in FIGS. 6 and 9a, and/or contain magnets 7 in the acoustic transducers 8 that help maintain the headphones 20 when they are in a semi-circular storage position 54. In one embodiment, generally shown in FIG. 6, one end 6 overlaps at least three inches of the spring band 22 when in a storage position 54. In yet other embodiments of the invention the jewelry headphones 20 are not bi-stable because they cannot achieve a planar first storage position 52; however, the headphones 20 are otherwise mechanically biased so as to permit movement between a use position 50 and a semi-circular or curled storage position 54.

Movement of the jewelry headphones 20 between the use position 50 and the planar or semi-circular storage positions 52, 54 can be achieved by use of any mechanical componentry well known to persons of skill in the art, but generally comprising a flexible substrate biased to curl into a semi-circular storage position 54 similar to the one shown in FIG. 6. According to one embodiment, shown in FIG. 3, the jewelry headphone 20 may be made of an elongated strip of flexible metal spring bands 22 that are covered with an outer layer 24. The flexible spring bands 22 can be made of stainless steel, or other such operable materials chosen by a person of sound engineering judgment. The outer layer 24 can be made of fabric or plastic, or other such materials as chosen by a person of sound engineering judgment. The outer layer 24 is wrapped or otherwise encases the spring bands 22 in such a fashion as to operatively contain all, or portions of, various headphone components (described below) in close proximity or attachment to the spring bands 22. In some embodiments, the outer layer 24 is decorated with various team colors or logos, inspirational statements, or designs. In still other embodiments, the outer layer 24 consists of an inner side 23a and an outer side 25a, operatively joined to create a unitary outer layer 24, wherein the inner side 23a consists of a rubber material, or other material designed to releasably secure the device 20 to the owner's head when the jewelry headphones 20 are in the use position 50. The flexibility and biasing design of the spring bands—similar to those in the aforementioned “slap bracelet”—permits the application of spring tension to keep the headphones 20 securely positioned on the user's head when in the use position 50, and/or permits straightening into a planar first storage position 52, and/or slapped into a second storage position 54 where the spring bands are converted into a circular shape around the user's wrist or arm.

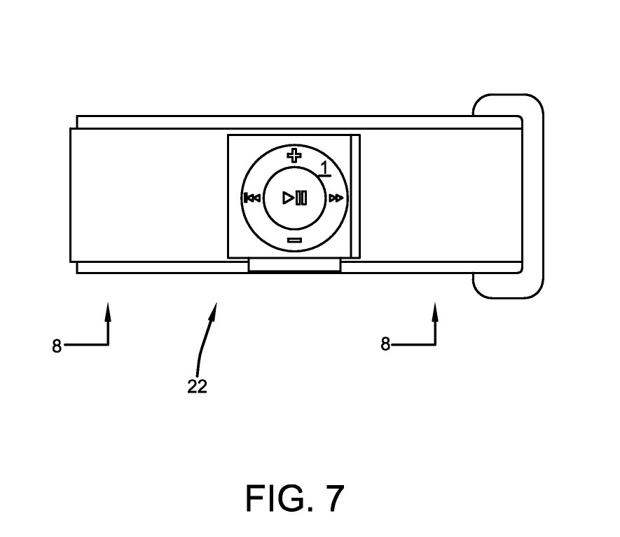

As shown in FIG. 3, the jewelry headphones 20 may have an arrangement, or varying combination, of electronic componentry that is well known in the art but includes at least one acoustic transducer 8 (aka—“speaker”) situated at an end 6 of the spring band 22; in a preferred embodiment, the jewelry headphone 20 has two acoustic transducers 8 situated at opposite ends 6 of the spring bands 22. Said acoustic transducers 8 are preferably situated on an inner side 23 of the spring bands 22 (or outer cover 24) so that the acoustic transducers 8 are situated in close proximity to the user's ears when the jewelry headphones 20 are in a use position 50. The acoustic transducers 8 may be enveloped entirely or partially within the outer layer 24; alternatively, as shown in FIG. 3, the acoustic transducers may reside outside of the outer layer 24. The acoustic transducers 8 are, in turn, connected to a battery 60 and/or wires 26—not shown, but well known in the art to supply power to electronics devices—that are connected to a wireless communications device 28 capable of wirelessly receiving and/or sending audio or other electronic signals from or to a personal audio electronics device 1. In some embodiments, one or more of the acoustic transducers 8 may have integrated batteries 60 and/or wireless communication devices 28, with the acoustic transducers 8 being in wired communication with each other. When the wireless communications device 28 (having an antenna) is synchronized and receives said audio signals 100 from a personal audio electronics device 1, according to Bluetooth® communications protocols or other such protocols known to those of skill in the art, the audio signals 100 are transferred via the wires 26 to the acoustic transducers 8, or are received directly by transducers 8 with integrated wireless devices 28, depending on the specific arrangement of electronic componentry. When the jewelry headphones 20 are properly situated in a use position 50, as shown generally in FIGS. 3 and 7D, the user is able to listen to the audio signals 100 broadcast by the acoustic transducers 8. Bluetooth® type wireless communications protocols, and the positioning and use of headphones and headsets, are well known in the art and will not be described in greater detail.

In some embodiments, instead of containing a wireless communication component 28, the jewelry headphones 20 may have a port, not shown, for releasably receiving a wire directly plugged into a personal electronics device. In still other embodiments, the headphones 20 may contain an electronics module 70 that communicates information about the positioning of the headphones—use 50, planar 50, transitional 53, or semi-circular 54—to the personal electronic device 1. In other embodiments, the jewelry headphones 20 can include a microphone 30 that is also in connection with the wireless communications device 28 so as to permit the device to act as a hands-free phone headset 32. In this embodiment, the personal audio electronics device 1 is a cellular phone 1a, and the user can listen to audio signals wirelessly sent from the phone 1, and speak into the microphone 30, with such spoken words being communicated wirelessly back to the phone 1u. In some embodiments, the personal electronics device 1 is designed and capable of receiving voice activation control signals 200—such as to increase or reduce volume, commence or terminate music or telephone calls, and other functions as known to persons of skill in the art—that are communicated by the user into the microphone 30. In some embodiments, the jewelry headphones 20 have one or more function buttons 40—as are known to those of skill in the art—that are operatively connected to the wireless communications device so as to communicate control signals 200 to the personal audio electronics device 1.

In still other embodiments, shown in FIG. 7, the acoustic transducer 8 is situated on an outer side 25 of the spring bands 22 (or outer cover 24), and is a speaker that is either hard-wired or wirelessly in communication with a personal audio electronics device 1 so as to broadcast audio signals at higher volumes (more like a jewelry loudspeaker than jewelry headphones). In this embodiment, the device's use position 50 is semi-circular, wherein the device is wrapped around the owner's wrist or upper arm region.

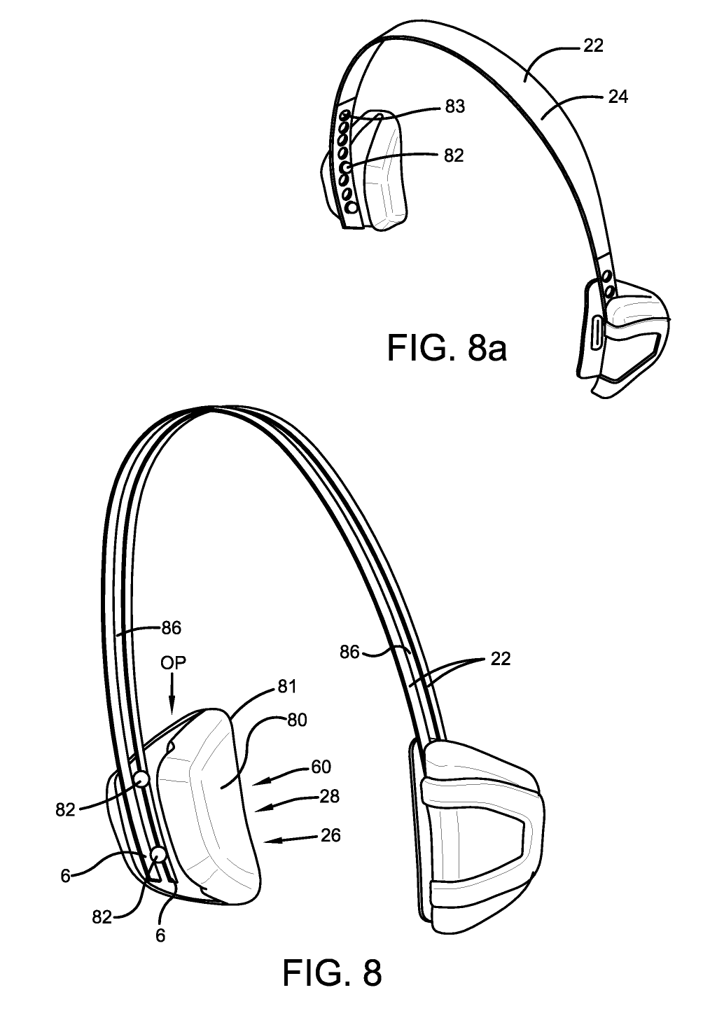

In another, perhaps preferred embodiment, the jewelry headphones 20 may utilize a pair of electrically conductive spring bands 22 (shown in FIG. 8 without the outer layer 24) situated in a parallel guide fashion within an outer layer 24 consisting of a molded nylon or rubber material (shown fully assembled in FIG. 9). The space between the parallel spring bands shall be referred to as the socket 86. The acoustic transducers 80 may consist of a substantially clam-shaped arrangement, as shown in FIG. 8, wherein one or more hinges 81 permit an opening and closing of said acoustic transducers 80. The acoustic transducer 80 may be inoperable when in an open position OP designed to permit positioning/adjustment of the speakers. In one embodiment, the acoustic transducers 80 may incorporate all necessary speaker componentry—battery 60, wireless communication device 28, and wiring 26, etc.—so that audio sounds may be broadcast without attachment to the spring bands 22. In one embodiment, the acoustic transducers 80 may also have one or more plugs 82 operatively designed to be received within the spring band 22 socket 86; when the speakers 80 are in a closed position CP the plugs 82 are engaged by the socket 86 created by the parallel arrangement of the pair of spring bands 22, as shown in FIG. 8; in this configuration, the speakers 80 are secured, and the pair of acoustic transducers 80 are effectively wired together by the spring bands 22 so that they are capable of operation. In some embodiments, the plugs 82 slide up and down within the spring bands 22 in order to effectuate proper positioning of the acoustic transducers 80 over the user's ears, while in other embodiments, shown in FIG. 8a, the plugs may be snap fit within holes 83 of varying placement in the outer layer 24 and spring bands 22. The acoustic transducers 80 may optionally contain magnets 7 in a location, shown in FIG. 9a, which releasably secure the speakers 80 when the headphones 20 are in a helical storage position 54 around the user's wrist or other appendage. The acoustic transducers 80 may be covered in any material known to persons of skill in the art, but in the preferred embodiment, by a perforated leather material.

In still other embodiments, shown in FIG. 8, the jewelry headphones 20 consist of an assembly of parts designed and assembled to be manipulated from a use position 50 into a storage position 54 generally resembling a bracelet. In one embodiment, the assembly of parts are slidably connected to facilitate conversion from the use position 50 to the storage position 54.

Numerous embodiments have been described herein. It will be apparent to those skilled in the art that the above methods and apparatuses may incorporate changes, modifications, and re-arrangements and additions of parts widely recognized as necessary or conventional in the art of headphones without departing from the general scope of this invention. It is intended to include all such modifications and alterations in so far as they come within the scope of the appended claims or the equivalents thereof.

Having thus described the invention, it is now claimed:

1. Headphones comprising:
a flexible substrate having two ends; and
one or more acoustic transducers operatively attached to the end(s) of said flexible substrate;
wherein the flexible substrate is: a) biased to curl into a semi-circular storage position substantially conforming and wrapping around a user's wrist when in a storage position, and b) adapted to releasably situate the headphones over a user's ears in a substantially U-shaped configuration when in a use position.

2. The headphones of claim 1, wherein:
The flexible substrate comprises metal spring bands.

3. The headphones of claim 2, wherein:
the spring bands are a bi-stable structure adapted to stably reside in a substantially planar first storage position and a semi-circular second storage position.

4. The headphones of claim 1, additionally comprising:
a wireless communications device adapted to wirelessly receive audio signals from an associated personal audio electronics device; and
a battery operatively connected to supply power to the wireless communications device and acoustic transducers.

5. The headphones of claim 4, wherein:
the acoustic transducers, battery, and wireless communication device are operatively connected by wires.

6. The headphones of claim 4, additionally comprising:
a microphone, operatively connected to the wireless communications device;
wherein the wireless communications device is adapted to send and receive audio signals to/from an associated personal audio electronics device.

7. The headphones of claim 4, additionally comprising:
an outer layer that substantially encases the flexible substrate, battery, and wireless communications device.

8. The headphones of claim 1, wherein:
one or more acoustic transducers have an integrated battery and wireless communication device.

9. The headphones of claim 8, additionally comprising:
a microphone, operatively connected to a wireless communications device adapted to send and receive audio signals to/from an associated personal audio electronics device.

10. The headphones of claim 9, wherein the wireless communication device is adapted to receive voice activation control signals and communicate said signals to an associated personal audio electronics device.

11. The headphones of claim 8, wherein the wireless communication device additionally comprises function buttons adapted to communicate control signals to an associated personal audio electronics device.

12. The headphones of claim 1, wherein:
an end overlaps at least three inches of the spring band when the headphones are in a semi-circular storage position.

13. The headphones of claim 13, wherein the overlapping end contains a magnet adapted to releasably secure the end to the spring band when in a semi-circular storage position.

14. The headphones of claim 1, wherein the spring band wraps around an associated user's wrist in a partially helical configuration when in a semi-circular storage position.

15. Headphones comprising:
a flexible substrate comprising a pair of electrically conductive metal spring bands having two ends and a parallel arrangement;
an outer layer that substantially encases the flexible substrate; and
one or more acoustic transducers, operatively attached to the end(s) of said flexible substrate;
wherein the flexible substrate is: a) biased to curl into a semi-circular helical storage position substantially conforming and wrapping around a user's wrist when in a storage position, and b) adapted to releasably situate the headphones over a user's ears in a substantially U-shaped configuration when in a use position; and
wherein connection between the acoustic transducers and spring bands establishes an electrical connection.

16. The headphones of claim 15, wherein:
the parallel arrangement of the spring bands creates a socket; and
the acoustic transducers additionally comprise plugs adapted to releasable engage the spring band socket.

17. The headphones of claim 16, wherein:
the acoustic transducers are of a substantially clam-shaped arrangement permitting selective movement between an open position and closed position; and
wherein operative arrangement of the acoustic transducers in a closed position around the spring bands creates an electrical connection, while transitioning the acoustic transducers to open position permits removal or repositioning of the speakers for better fit.

18. The headphones of claim 15, wherein:
the outer layer has holes adapted to receive the acoustic transducer plugs; and
wherein the acoustic transducer plugs are located in a positioned that is adapted to pass through the outer layer holes and be securely engaged within the spring band socket when the acoustic transducers are in a closed position.

19. The headphones of claim 14, additionally comprising:
a microphone, operatively connected to the acoustic transducer's wireless communications device;
wherein the wireless communications device is adapted to send and receive audio signals to/from an associated personal audio electronics device.
